(19) United States
(12) Patent Application Publication
(10) Pub. No.: US 2007/0212147 A1
(43) Pub. Date: Sep. 13, 2007

(54) Thermal head printing method and device

(76) Inventors: Sanji Kawakami, Tsurugashima-shi (JP); Ribun Tazaki, Tsurugashima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/707,902

(22) Filed: Feb. 20, 2007

(30) Foreign Application Priority Data
Mar. 2, 2006 (JP) 2006-056468

(51) Int. Cl. B41J 2/315

(52) U.S. Cl. 400/120.01

(57) ABSTRACT

Provided are a thermal head printing method and device carrying out printing on a place to be printed of a moving object by a thermal head arranged not to move in a moving direction of the printing object. In the thermal head printing device carrying out printing on the place to be printed of a packaging film (10) as the moving object supplied between a thermal head (8), arranged not to move in the moving direction of the moving object, and a platen (9), the printing device comprises moving rolls (15, 16) arranged on both sides of the platen (9) to change a stagnation quantity of the packaging film (10) on a side of the platen (9). The printing is carried out by the moving rolls (15, 16) being displaced to change a moving velocity of the place to be printed. The place to be printed of the packaging film (10) is moved at a predetermined velocity held within a velocity range within which a clear printing can be carried out by the thermal head. Thereby, even on the place to be printed of the packaging film (10) moving at a velocity higher than, or lower than, the predetermined velocity, a clear printing can be carried out.

### BACKGROUND OF THE INVENTION

1. Field of the Invention

The present invention relates to a thermal head printing method and device carrying out printing on a place to be printed of a moving object supplied between a thermal head, arranged not to move in a moving direction of the moving object, and a platen.

2. Description of the Prior Art

In a packing apparatus or the like, a packaging film that is being transferred is intermittently applied with printing of data, such as a series number of manufacture, date of manufacture, tastable time period, etc., on each of places to be printed arranged with predetermined intervals on the packaging film. As the packaging film is often supplied into the packaging apparatus at velocities changing corresponding to packaging processes, in order for a thermal head to make a clear printing on an object to be printed (hereinafter referred to as a printing object) of which a transfer velocity changes, such as the packaging film, there have been carried out various devices. That is, as the printing by the thermal head is carried out such that while a relative movement is generated between the printing object and the thermal head, the thermal head is applied with a pulse current so that printing of predetermined letters or marks is effected by points of printing generated by pulses. Hence, an aggregation of the points forming the printing is necessary to be formed with a certain density and if a relative velocity between the printing object and the thermal head becomes too large or too small, printing with a predetermined clearness could not be carried out. Therefore, the devices of the printing have been carried out for making the relative velocity held within a predetermined range, or preferably held to a predetermined single velocity.

As one example thereof, as disclosed by Patent Document 1 or Patent Document 2 mentioned below, a transfer velocity of a printing object is detected and a feeding velocity of the printing object is controlled so that velocity of the printing object is synchronized with velocity of printing by a thermal head.

Also, as disclosed by Patent Document 3, a transfer velocity of a printing object that is being transferred is detected and a thermal head is applied with a current of which a printing current (pulse) velocity is changed synchronously with the detected transfer velocity so that printing is carried out on the printing object of which velocity changes. According to the printing method disclosed by the Patent Document 3, however changes the velocity of the printing object, following the velocity, a predetermined printing can be clearly carried out. Hence, this method can be said a very effective technology. Nevertheless, in order to make control of the printing velocity by this printing method, a precision control system of printing is needed and this invites a cost increase of the printing device.

On the other hand, a packaging velocity in a packaging apparatus is becoming more and more increased and thus the transfer velocity of the packaging film to be supplied into the packaging apparatus is also becoming larger. This means that the time allowed for the printing to be done on the packaging film becomes more and more shortened. As the printing velocity becomes larger and the time for the printing becomes shorter, not only the energy required for the printing by the thermal head increases to thereby cause a case where the thermal head is used beyond its standard capacity but also no sufficient time is given for the thermal head to heat a ribbon tape to thereby cause a case where a clear printing is made difficult.

From the viewpoint of the packaging velocity, it is demanded that a clear printing can be obtained even at the velocity of 1000 mm/second or so.

Also, in order for the thermal head to carry out the clear printing, the relative movement at a certain velocity or more is needed between the thermal head and the printing object. Nevertheless, when the printing is to be done on the printing object in a packaging line, even if the printing object is moving at a velocity lower than a limit velocity of printing, there is a case where the printing is needed according to packaging processes. Hence, even at a velocity lower than the printing limit velocity, it is required that a clear printing can be carried out. A low velocity of the printing object at which a clear printing can be done is 20 mm/second or so, for example.

| | |
|---|---|
| (Patent Document 1) | Japanese laid-open patent application |
| | No. 1985-067183 |
| (Patent Document 2) | Japanese laid-open patent application |
| | No. 1990-153769 |
| (Patent Document 3) | Japanese laid-open patent application |
| | No. 1996-217039 |

### SUMMARY OF THE INVENTION

With a view to solve the problems in the prior art, it is an object of the present invention to provide a thermal head printing method enabling a thermal head to carry out a clear printing on a place to be printed of a printing object that is moving, wherein the thermal head is arranged not to move in a moving direction of the printing object but the printing object is moved at a velocity within a velocity range within which the clear printing can be carried out, even when the printing object is moving at a velocity higher than a limit velocity of printing by the thermal head or even when the printing object is moving at a velocity lower than the limit velocity of printing by the thermal head or, according to the case, even when the printing object is in a stopping state. It is also an object of the present invention to provide a thermal head printing device according to the above-mentioned thermal head printing method.

As a printing method to achieve the above-mentioned objects, the present invention provides a thermal head printing method carrying out printing on a place to be printed of a moving object supplied between a thermal head, arranged not to move in a moving direction of the moving object, and a platen, characterized in that the printing is carried out on the place to be printed such that when the place to be printed comes to a position of the printing by the thermal head, if a moving velocity of the moving object is lower than a predetermined velocity, the place to be printed of the moving object is forcibly displaced to the moving direction of the moving object to be moved at the predetermined velocity or more and when the place to be printed comes to the position of the printing by the thermal head, if the moving velocity of the moving object is higher than the predetermined velocity, the place to be printed of the moving object is forcibly displaced to a direction reverse of the moving direction of the moving object to be moved at the predetermined velocity or less.

Also, as a printing device to achieve the above-mentioned objects, the present invention provides a thermal head printing device carrying out printing on a place to be printed of a moving object supplied between a thermal head, arranged not to move in a moving direction of the moving object, and a platen, characterized in that the printing device comprises moving rolls arranged on both sides of the platen to change a stagnation quantity of the moving object on a side of the platen and the printing is carried by the moving rolls being displaced to change a moving velocity of the place to be printed so that the place to be printed of the moving object is moved at a predetermined velocity.

In the printing method and device according to the present invention, the predetermined velocity held as the moving velocity of the place to be printed is preferable to be a predetermined single velocity but this predetermined velocity may also be of a value set within a certain range.

According to the thermal head printing method of the present invention, if the moving velocity of the moving printing object is higher than the predetermined velocity set within a velocity range within which a clear printing can be carried out by the thermal head, the place to be printed of the moving printing object is forcibly displaced to the reverse direction of the moving direction of the moving printing object so that the place to be printed is moved at the predetermined velocity or less. Also, if the moving velocity of the moving printing object is lower than the predetermined velocity, the place to be printed of the moving printing object is forcibly displaced to the moving direction of the moving printing object so that the place to be printed is moved at the predetermined velocity or more. By so doing, the printing can be clearly carried out. While the printing object is being moved at the predetermined velocity or within the velocity range at which or within which the clear printing can be carried out by the thermal head, the forcible displacement of the place to be printed of the printing object, as mentioned above, is not carried out. In this way, according to the present invention, while the moving velocity of the printing object is largely changing, a clear printing can be carried out by a simple means, even when the velocity of the printing object becomes higher than the predetermined velocity set within the velocity range within which the clear printing can be carried out by the thermal head or even when the velocity of the printing object becomes lower than the predetermined velocity. Especially, according to the printing method of the present invention, the printing can be carried out without a feeding velocity of entire ribbon tape being made higher and a feeding mechanism of the ribbon tape can be facilitated.

Also, according to the thermal head printing method of the present invention, by displacing the moving rolls arranged on both sides of the platen to change the stagnation quantity of the printing object on a side of the platen, the printing object is forcibly displaced so that the printing object is moved at the predetermined velocity at which a clear printing can be carried out by the thermal head. Thereby, the printing can be easily carried out.

According to the thermal head printing device of the present invention, a printing device using a thermal head by which the above-mentioned printing method of the present invention can be easily realized is provided. Especially, according to the printing device of the present invention, only by providing the moving rolls on both sides of the platen and displacing the moving rolls, a clear printing can be carried out by the thermal head on the printing object that is moving at a velocity within a wide range of velocities including a velocity higher than a predetermined velocity set within a velocity range within which the clear printing can be carried out by the thermal head or including a velocity lower than the predetermined velocity.

### BRIEF DESCRIPTION OF THE DRAWING

FIGS. 1(a)-1(c) are explanatory views showing construction of a printing device of an embodiment according to the present invention.

### DESCRIPTION OF THE PREFERRED EMBODIMENT

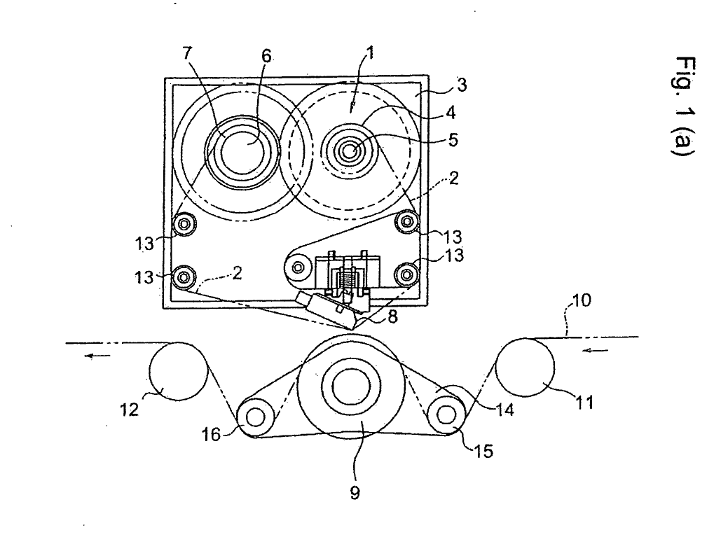

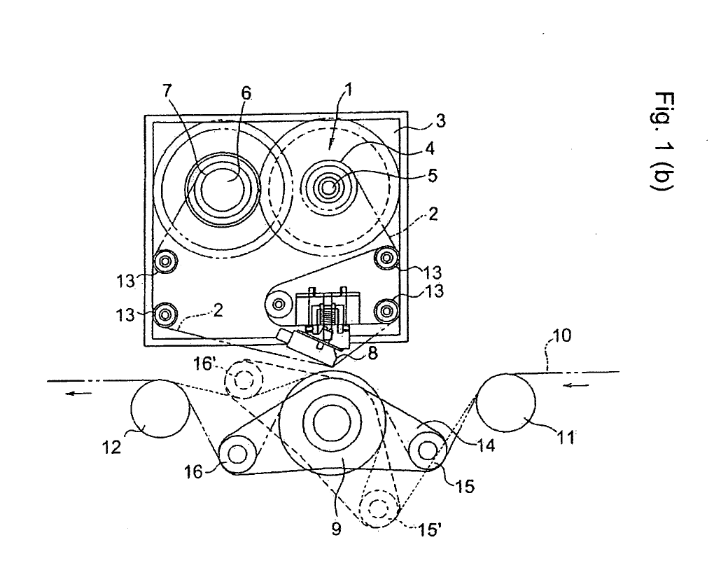

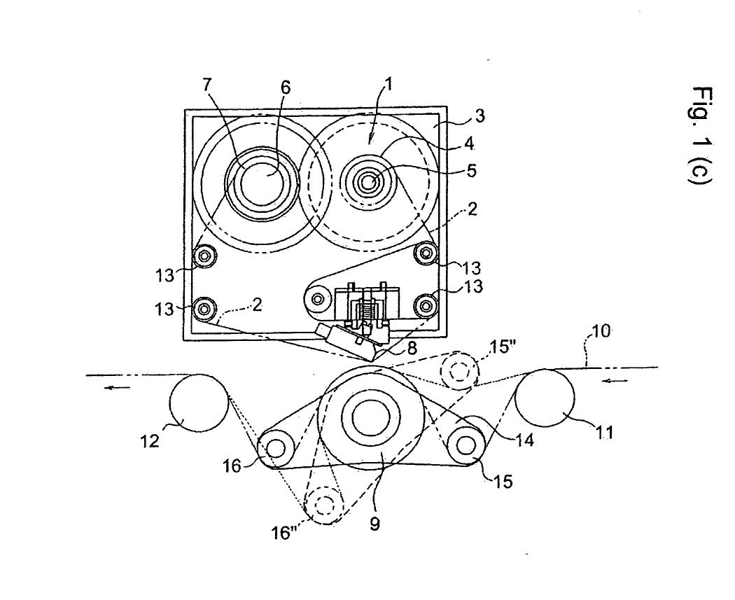

Herebelow, the present invention will be more concretely described based on an embodiment with reference to FIG. 1 illustrating a thermal head printing method and device according to the present invention.

In FIG. 1 showing an entire construction of the device, numeral 1 designates a ribbon tape master roll that supplies a ribbon tape 2. A reel 4 of the ribbon tape master roll 1 is rotatably supported being fitted in a spindle 5 that is supported to a device frame 3. Numeral 6 designates another spindle that is supported to the device frame 3. A reel 7 is fitted in the spindle 6 and the ribbon tape 2 unwound from the ribbon tape master roll 1 is wound around the reel 7. Numeral 8 designates a line thermal head and numeral 9 a platen that is arranged below the line thermal head 8. Numeral 10 designates a packaging film as an object to be printed. Numerals 11 and 12, respectively, designate guide rollers. The packaging film 10 is transferred on the guide roller 11, platen 9 and guide roller 12 at changing velocities in a direction of arrows to be supplied into a packaging apparatus (not shown). Numeral 13 designates a plurality of ribbon tape guide rollers that guide the ribbon tape 2.

The ribbon tape 2 unwound from the ribbon tape master roll 1 is guided by the ribbon tape guide rollers 13 to pass through a lower side of the line thermal head 8 to be wound around the reel 7 fitted in the spindle 6. Numerals 15, 16 designate two moving rolls that are arranged on both sides of the platen 9. The moving rolls 15, 16 in this state are rotatably supported to a triangular frame 14. The platen 9 comprises a swivel shaft (not shown) that is coaxially provided with the platen 9 and the frame 14 is swingingly rotatable around the swivel shaft. When the frame 14 is swingingly rotated around the swivel shaft, the moving rolls 15, 16 are likewise rotated (revolved) together with the frame 14 around the swivel shaft that is coaxial with the platen 9. When the packaging film 10 is transferred, the packaging film 10 is arranged relative to the platen 9 and the moving rolls 15, 16 arranged on both sides of the platen 9 such that a lower surface of the packaging film 10 makes contact with an upper side surface of the platen 9 and an upper surface of the packaging film 10 makes contact with a lower side surface of each of the moving rolls 15, 16. Thus, when the moving rolls 15, 16 are revolved around the swivel shaft, the moving rolls 15, 16 move to positions 15′, 16′, for example, in FIG. 1(b) or to positions 15″, 16″, for example, in FIG. 1(c). This functions to cause the packaging film 10 to form a stagnation on any one side of the platen 9. It is to be noted that when the packaging film 10 on the platen 9 comes to the position of the line thermal head 8, the packaging film 10 and the ribbon tape 2 are lapped together and the line thermal head 8 effects a predetermined printing on the packaging film 10.

Next, with respect to the line thermal head printing device constructed as mentioned above, the function will be described.

The packaging film 10 that is transferred on the guide roller 11, platen 9 and guide roller 12 is supplied into the not shown packaging apparatus. The packaging film 10 so transferred is intermittently applied with the printing of data, such as a series number of manufacture, date of manufacture, tastable time period, etc., on each of places to be printed arranged with predetermined intervals corresponding to articles to be packaged. This printing is carried out such that when the place to be printed of the packaging film 10 comes to the position on the platen 9, it is detected and a control device operates the line thermal head 8 so that the ribbon tape 2 unwound at a predetermined velocity from the ribbon tape master roll 1 to be wound around the reel 7 is caused to abut on the packaging film 10 on the platen 9 to thereby apply the printing.

Transfer velocity of the packaging film 8 is previously set to a predetermined velocity that is decided within a velocity range within which a clear printing can be carried out by the line thermal head 8. When the printing is to be carried out on the packaging film 10, if a film velocity detecting device (not shown) detects that the transfer velocity of the packaging film 10 is higher than the predetermined velocity, the moving rolls 15, 16 arranged on both sides of the platen 9 are displaced toward the position 15′, 16′. The displacement of the moving rolls 15, 16 is controlled so that the detected velocity of the packaging film 10 is lowered and the printing by the line thermal head 8 can be carried out at the predetermined velocity of the packaging film 10. That is, at this time, the packaging film 10 to be led onto the platen 9 is moved to be drawn back to a direction reverse of the transfer direction of the packaging film 10 (rightward in FIG. 1) so that the transfer velocity of the packaging film 10 on the platen 9 is lowered and the printing is carried out on the place to be printed of the packaging film 10 of which velocity is so lowered to the predetermined velocity.

Reversely, when the printing is to be carried out on the packaging film 10, if the not shown film velocity detecting device detects that the transfer velocity of the packaging film 10 is lower than the predetermined velocity that is decided within the velocity range of the printing by the line thermal head 8, the moving rolls 15, 16 arranged on both sides of the platen 9 are displaced toward the position 15″, 16″. The displacement of the moving rolls 15, 16 is controlled so that the detected velocity of the packaging film 10 is increased to the predetermined velocity. That is, at this time, the packaging film 10 on the platen 9 is moved to be drawn forward to the transfer direction of the packaging film 10 (leftward in FIG. 1) so that the transfer velocity of the packaging film 10 on the platen 9 is increased and the printing is carried out on the place to be printed of the packaging film 10 of which velocity is so increased to the predetermined velocity.

In this way, according to the printing device shown in FIG. 1, the transfer velocity of the packaging film to be printed can be easily adjusted to a predetermined velocity by a simple means. That is, when the printing is to be carried out on the packaging film, if the transfer velocity of the packaging film is higher than a predetermined velocity of the packaging film that is decided within a velocity range within which a clear printing can be carried out by the thermal head or if the transfer velocity of the packaging film is lower than the predetermined velocity, adjustment is carried out so that the packaging film is transferred at the predetermined velocity. Thereby, the clear printing can be carried out.

In the foregoing, while the present invention has been concretely described on the basis of the embodiment, the present invention is not limited to the embodiment but, needless to mention, may be added with various alterations and modifications within the scope of invention as defined by claims as appended herein.

For example, while the velocity adjusting means of the packaging film has been described by the construction using the moving rolls 15, 16 and frame 14, the velocity adjusting means is not limited to such a forcibly displacing mechanism but may be of mechanisms of other constructions. Also, while a roller is used as the platen, a member of a flat plate shape may also be used.

What is claimed is:

1. A thermal head printing method carrying out printing on a place to be printed of a moving object supplied between a thermal head, arranged not to move in a moving direction of said moving object, and a platen, wherein the printing is carried out on the place to be printed such that when the place to be printed comes to a position of the printing by said thermal head, if a moving velocity of said moving object is lower than a predetermined velocity, the place to be printed of said moving object is forcibly displaced to the moving direction of said moving object to be moved at the predetermined velocity or more and when the place to be printed comes to the position of the printing by said thermal head, if the moving velocity of said moving object is higher than the predetermined velocity, the place to be printed of said moving object is forcibly displaced to a direction reverse of the moving direction of said moving object to be moved at the predetermined velocity or less.

2. A thermal head printing method as claimed in claim 1, wherein to forcibly displace the place to be printed of said moving object is carried out by displacing moving rolls arranged on both sides of said platen.

3. A thermal head printing device carrying our printing on a place to be printed of a moving object supplied between a thermal head, arranged not to move in a moving direction of said moving object, and a platen, wherein said printing device comprises moving rolls arranged on both sides of said platen to change a stagnation quantity of said moving object on a side of said platen and the printing is carried out by said moving rolls being displaced to change a moving velocity of the place to be printed so that the place to be printed of said moving object is moved at a predetermined velocity.
